(19) United States
(12) Patent Application Publication
(10) Pub. No.: US 2023/0004474 A1
(43) Pub. Date: Jan. 5, 2023

(54) MACHINE LEARNING TO INFER POOR USER EXPERIENCE WITH ELECTRONIC SYSTEM

(71) Applicant: Lenovo (Singapore) Pte. Ltd., Singapore (SG)

(72) Inventors: Jordan Hansen, Boise, ID (US); Stefan Legg, Perrysburg, OH (US)

(21) Appl. No.: 17/364,051

(22) Filed: Jun. 30, 2021

(51) Int. Cl. G06F 11/34; G06K 9/62; G06N 3/08

(52) U.S. Cl. CPC G06F 11/3438; G06K 9/628; G06N 3/08

(57) ABSTRACT

In one aspect, a device may include a processor and storage accessible to the processor. The storage may include instructions executable by the processor to determine an insufficiency related to a system in a first instance based on input from an end user. The instructions may also be executable to analyze first data related to the first instance and, based on the analysis, determine that the insufficiency has or will occur again based on second data also related to the system but that corresponds to a second instance occurring after the first instance. The instructions may then be executable to proactively address the insufficiency based on determination that the insufficiency has or will occur again. In some examples, the determination that the insufficiency has/will occur again may be performed using an artificial neural network trained using the first data to infer whether the insufficiency has or will occur again.

### FIELD

The disclosure below relates to technically inventive, non-routine solutions that are necessarily rooted in computer technology and that produce concrete technical improvements. In particular, the disclosure below relates to machine learning to infer poor user experiences with electronic systems.

### BACKGROUND

As recognized herein, advanced device networking as presently used in many systems involves numerous interconnected nodes and pieces of software operating in concert. However, as further recognized herein, the network components and nodes do not always operate in concert as desired, which can lead to bad user experiences. But given that the numerous interconnected network components and nodes might be using different standards and operating software, the present disclosure further recognizes that current network and device diagnostic systems are insufficient for adequately identifying and addressing problems that might arise anywhere across these numerous components. Therefore, there are currently no adequate solutions to the foregoing computer-related, technological problem.

### SUMMARY

Accordingly, in one aspect a first device includes at least one processor and storage accessible to the at least one processor. The storage includes instructions executable by the at least one processor to identify a first poor user experience with a system based on user input indicating the first poor user experience. The instructions are also executable to use data related to operation of the system to determine one or more causes of the first poor user experience. The instructions are then executable to predict that a second poor user experience will occur based on subsequent identification of one or more of the causes. Based on the prediction, the instructions are executable to proactively prevent the second poor user experience from occurring and/or present a notification in advance of the second poor user experience.

In some examples, the determination may be performed using at least one artificial neural network (ANN) to process the data and infer from the data one or more system insufficiencies indicating the one or more causes. Further, in some examples the instructions may be executable to train the ANN using the data as input, where the data may be labeled with the one or more causes for training the ANN. The data may also be labeled as being a poor user experience for training the ANN, with the data labeled by the first device as being a poor user experience based on the user input. The ANN may then be trained using the labeled data and one or more machine learning algorithms such as a multi-label classification learning algorithm. Additionally, if desired the prediction itself may be made using the ANN as trained or not.

In various example implementations, the system may include the first device, a second device different from the first device and associated with an end user, and/or a server providing an online service to an end user.

In another aspect, a method includes determining an insufficiency of a system based on input from an end user indicating the insufficiency exists in a first instance. The method also includes using first data related to the system to identify one or more reasons for the insufficiency and then determining that the insufficiency has or will occur again based on subsequent identification of one or more of the reasons from second data different from the first data. The second data is also related to the system and corresponds to a second instance occurring after the first instance. The method then includes, based on determining that the insufficiency has or will occur again, proactively addressing the insufficiency.

In various examples, the insufficiency may be proactively addressed by attempting to prevent or mitigate the insufficiency, and/or by presenting a notification at an end-user device regarding the insufficiency.

Also in various examples, the method may include using at least one artificial neural network (ANN) to infer, from the second data, that the insufficiency has or will occur again. The ANN may be trained using the first data and at least one machine learning algorithm.

In still another aspect, at least one computer readable storage medium (CRSM) that is not a transitory signal includes instructions executable by at least one processor to determine an insufficiency related to a system in a first instance and analyze first data related to the first instance. Based on the analysis, the instructions are executable to determine that the insufficiency has or will occur again based on second data different from the first data. The second data is also related to the system and corresponds to a second instance occurring after the first instance. The instructions are then executable to proactively address the insufficiency based on determination that the insufficiency has or will occur again.

Thus, in some examples the instructions may be executable to determine the insufficiency related to the system in the first instance based on user input indicating the insufficiency exists in the first instance.

Also in some examples, the analysis may be used to recognize a pattern in the second data that is similar to a pattern indicated in the first data, where recognition of the pattern from the second data may contribute to the determination that the insufficiency has or will occur again. If desired, in various examples the system in the first and second instances may be facilitating a video conference.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 is a block diagram of an example network of devices consistent with present principles;

FIG. 3 shows an example graphical user interface (GUI) at which an end user may indicate a poor user experience consistent with present principles;

FIG. 4 shows example artificial intelligence architecture that may be used consistent with present principles;

FIG. 5 illustrates example logic in example flow chart format that may be executed by a device consistent with present principles;

FIGS. 6-9 show various example GUIs that may be presented on a display regarding proactively addressing one or more potential poor user experiences consistent with present principles; and

FIG. 10 shows an example GUI that may be presented on a display for configuring one or more settings of the system to operate consistent with present principles.

### DETAILED DESCRIPTION

Among other things, the detailed description below describes use of methods and devices that can predict poor user experiences and one or both of notify the user and/or prevent the poor user experience. So, for example, when a user has a poor user experience, the user can flag it as so with a thumbs up or thumbs down or other user input. After a thumbs down, the system can analyze all diagnostic information related to the associated session and apply machine learning to predict and possibly prevent future poor user experiences, notify end users, and/or notify back-end system administrators. The poor experiences may be based on one or a combination of things that have been identified as together leading to the prior poor user experience.

Machine learning inputs that may be used include the user input of the bad experience, collected diagnostic information around existing times when the poor experience occurred (such as error logs as well as long loading times and other insufficient system resources, server errors, etc.), and/or diagnostics/metric data from the poor experiences (such as time of day when the problem occurred, how many people were in on the same session or using the same system generally, the system load, database load, memory load, etc.). As indicated above, the data may be limited to a particular window of time such as a particular discrete segment of a video conference during which an error occurred, or for the particular video conference as a whole. Then as the system learns through machine learning, the system can better identify, report, and attempt to fix bad experiences for the detected problem in the future.

Thus, the outputs from the machine learning model may include possible causes of a past or current bad experience, notification of a potential bad experience along with possibly offering solutions, and/or correcting predicted bad experiences before they even happen. The notification(s) may be presented to the end user and/or may even be presented to back-end system administrators along with recommendations on how the same or a similar problem was solved in the past.

As a use case, suppose a teacher is monitoring student screens during online distance learning using a video conferencing service. Some of the student screens may unexpectedly go offline. The teacher may flag this as a poor experience. The system may then analyze hardware data from the students' computers that went offline, data on the network status at the time, database load data, server load data, etc. to identify patterns in this data with machine learning and predict similar poor experiences in the future to help mitigate them in the future.

Again, in terms of machine learning, note that present principles may employ machine learning models, including deep learning models. Machine learning models use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), recurrent neural network (RNN) which may be appropriate to learn information from a series of network diagnostic inputs, and a type of RNN known as a long short-term memory (LSTM) network/unit. Support vector machines (SVM) and Bayesian networks also may be considered to be examples of machine learning models for use consistent with present principles.

As understood herein, performing machine learning involves accessing and then training a model on training data to enable the model to process further data to make predictions. A neural network may include an input layer, an output layer, and multiple hidden layers in between that that are configured and weighted to make inferences about an appropriate output.

Prior to delving further into the details of the instant techniques, note with respect to any computer systems discussed herein that a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino Calif., Google Inc. of Mountain View, Calif., or Microsoft Corp. of Redmond, Wash. A Unix® or similar such as Linux® operating system may be used. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any general-purpose single- or multi-chip processor that can execute logic by means of various lines such as address lines, data lines, and control lines and registers and shift registers. Moreover, any logical blocks, modules, and circuits described herein can be implemented or performed with a general-purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may also be embodied in a non-transitory device that is being vended and/or provided that is not a transitory, propagating signal and/or a signal per se (such as a hard disk drive, CD ROM or Flash drive). The software code instructions may also be downloaded over the Internet. Accordingly, it is to be understood that although a software application for undertaking present principles may be vended with a device such as the system 100 described below, such an application may also be downloaded from a server to a device over a network such as the Internet.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/or made available in a shareable library.

Logic when implemented in software, can be written in an appropriate language such as but not limited to hypertext markup language (HTML)-5, Java/JavaScript, C# or C++, and can be stored on or transmitted from a computer-readable storage medium such as a random access memory (RAM), read-only memory (ROM), electrically erasable programmable read-only memory (EEPROM), a hard disk drive or solid state drive, compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. As is well known in the art, the term “circuitry” includes all levels of available integration, e.g., from discrete logic circuits to the highest level of circuit integration such as VLSI and includes programmable logic components programmed to perform the functions of an embodiment as well as general-purpose or special-purpose processors programmed with instructions to perform those functions.

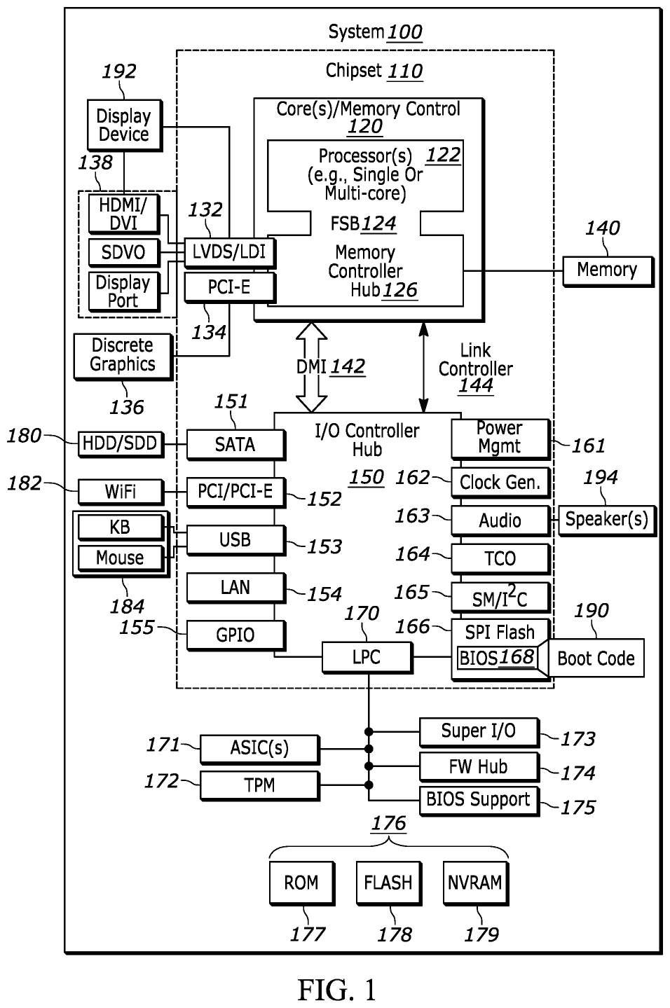

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card (including, e.g., one of more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, a Bluetooth network using Bluetooth 5.0 communication, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes basic input/output system (BIOS) 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 may provide for communication with various devices, networks, etc. For example, where used, the SATA interface 151 provides for reading, writing, or reading and writing information on one or more drives 180 such as HDDs, SDDs or a combination thereof, but in any case, the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Additionally, though not shown for simplicity, in some embodiments the system 100 may include a gyroscope that senses and/or measures the orientation of the system 100 and provides related input to the processor 122, as well as an accelerometer that senses acceleration and/or movement of the system 100 and provides related input to the processor 122. Still further, the system 100 may include an audio receiver/microphone that provides input from the microphone to the processor 122 based on audio that is detected, such as via a user providing audible input to the microphone. The system 100 may also include a camera that gathers one or more images and provides the images and related input to the processor 122. The camera may be a thermal imaging camera, an infrared (IR) camera, a digital camera such as a webcam, a three-dimensional (3D) camera, and/or a camera otherwise integrated into the system 100 and controllable by the processor 122 to gather still images and/or video. Also, the system 100 may include a global positioning system (GPS) transceiver that is configured to communicate with at least one satellite to receive/identify geographic position information and provide the geographic position information to the processor 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

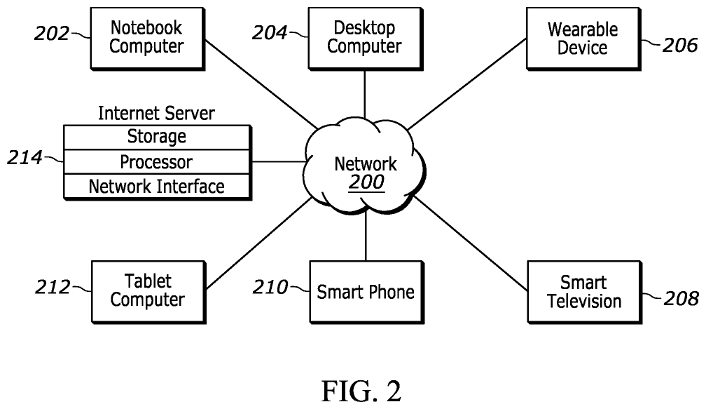

Turning now to FIG. 2, example devices are shown communicating over a network 200 such as the Internet in accordance with present principles. It is to be understood that each of the devices described in reference to FIG. 2 may include at least some of the features, components, and/or elements of the system 100 described above. Indeed, any of the devices disclosed herein may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, and a server 214 such as an Internet server that may provide cloud storage accessible to the devices 202-212. It is to be understood that the devices 202-214 may be configured to communicate with each other over the network 200 to undertake present principles.

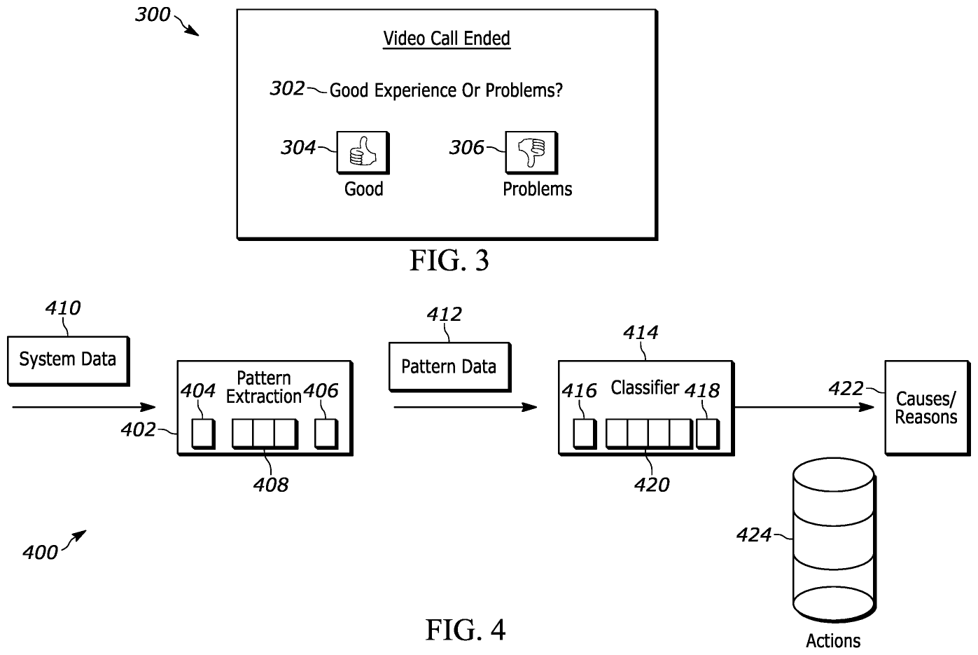

Now in reference to FIG. 3, it shows an example graphical user interface (GUI) 300 that may be presented on the display of an end user's device responsive to conclusion of a video conference call conducted using the device. The device might be a smartphone, tablet computer, laptop, or wearable device for example.

As shown, the GUI 300 may include a prompt 302 asking the end user if the end user's experience during the video conference was good or if the user experience problems like client software not loading, being dropped from the call, having interruptions in the data streams from other conference participants, etc. The user may select the selector 304 to provide user input that the user had a good experience, whereas selector 306 may be selected to provide user input that the user had a poor user experience.

Responsive to selection of one of the selectors 304, 306, the user's device may then transmit the user's selection to one or more remotely-located servers to save the user's selection and the session's data in storage. Session data may include many different types of data related to the system (including its network components) as used to conduct the video conference. Thus, session data may include network status, database load (e.g., number of read and/or write actions within a threshold amount of time), server load, server errors, etc.

In addition to being stored, the user's selection and the session data may also be provided to an artificial intelligence (AI) model 400 as shown in FIG. 4 for training the model 400 to identify similar problems in the future and act proactively to fix or mitigate a potential bad user experience for a future conference call. Training may be performed using one or more machine learning algorithms, including one or more deep learning algorithms if desired. The model 400 itself may be stored and deployed at a server or even an end user device.

With respect to the AI architecture of the model 400 as shown in FIG. 4, the model 400 may include a pattern extraction module 402 that may be established by one or more artificial neural networks (ANNs), such as one or more recurrent neural networks (RNNs) and other suitable ANNs, and even one or more long short-term memory (LTSM) units in particular. Thus, each of the module's ANN(s) may have an input layer 404, output layer 406, and multiple hidden layers 408 in between such as Softmax layers, ReLU layers, and batch normalization layers. During execution/deployment, the module 402 may receive as input session/system data 410 for a given system session (for video conferencing or other purposes) that is currently ongoing or that is scheduled to occur within a threshold time in the future (e.g., within five minutes). The session/system data may include data related to different network operating parameters, system node metrics and error reports, for example.

The module 402 may then process the data through its layers and provide as output 412 pattern data and/or system issue data that it has inferred from the input. The output 412 may in turn be provided to a classifier module 414 that may itself include one or more ANNs, like RNNs and other suitable ANNs and LTSM units in particular, that each also have an input layer 416, output layer 418, and multiple hidden layers 420 in between such as Softmax layers, ReLU layers, and batch normalization layers. The module 414 may thus process the output 412 from the module 402 as input to its own input layer and use one or more classification algorithms to then provide as output 422 classification of one or more causes or reasons for a system insufficiency and/or poor user experience as inferred from the data 412.

Then based on the output 422, the server or other device may access a local or remote relational database 424 that correlates particular insufficiencies/poor experiences with respective actions the server can proactively take upon inferring such things during a given system session that is currently ongoing or is expected to take place in the future, such as within a threshold number of minutes of the current time. The actions may include notifying an end user actively participating in the session or a user that is to participate in the session shortly. The actions may also include the server/other device autonomously taking steps to cure or mitigate the issue. The database may be preconfigured by a developer or system administrator, for example. However, further note that in addition to or in lieu of using the database 424, the classifier module 414 itself may be trained to infer appropriate action to proactively take, e.g., using labeled training data indicating various actions to take based on various sets of data indicating various network/component patterns and metrics.

During training but more generally, note the modules 402, 414 may be variously trained using one or more machine learning algorithms in supervised fashion, unsupervised fashion (e.g., using deep learning), semi-supervised fashion, using reinforcement learning, using dimensionality reduction, etc. Thus, session data from a prior session for which user input has been received indicating a poor experience may be labeled with the poor user experience, and/or labeled with one or more causes of the poor experience as labeled by an administrator or as previously output by the model 400 during execution/deployment of the model 400 (e.g., prior to training or after any given training session). If a given block of session data to be used for training is assigned both labels (poor experience and the particular cause), a multi-label classification learning algorithm may be used. Also note that in some examples, session data for good user experiences or sessions where no negative user input was provided may also be used for training to further optimize the model 400.

As for the ANNs themselves that are to be trained, they may initially include random weightings/functions for the respective nodes of the respective layers and undergo extensive training to render desired outputs. Additionally, or alternatively, one or more nodes of the layers for each ANN may be preconfigured by a developer to recognize certain issues or bugs for a given set of patterns, trends and metrics and infer a given output, which may then be further refined through machine learning over time. In either case, the machine learning may be triggered manually and/or responsive to each reported bad user experience.

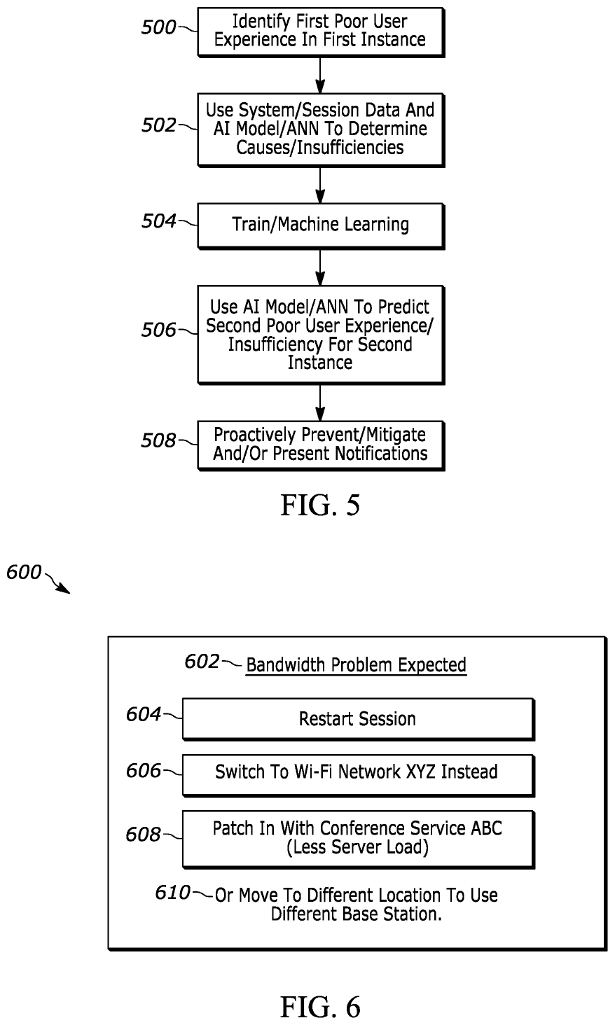

Continuing the detailed description in reference to FIG. 5, it shows example logic that may be executed in any appropriate combination by a device such as the system 100, end user device, and/or server providing on online service consistent with present principles in order to employ the above-described architecture/model 400. Beginning at block 500, the device may identify a first poor user experience in a first instance (e.g., for a first video conferencing session) based on user input indicating the poor experience. From block 500 the logic may then proceed to block 502.

At block 502 the device may use system/session data and an AI model such as the model 400 to determine the causes or system insufficiencies leading to the poor user experience. The logic may then proceed to block 504 where the model may be trained as described above to, in the future, infer similar system insufficiencies to proactively take action for other instances. Thus, at block 506 the device may use the AI model to predict a second poor user experience or system insufficiency for a second instance (e.g., for a different video conferencing session between the same or different participants).

Responsive to the predicting performed at block 506, the logic may then proceed to block 508 where the device may proactively attempt to prevent or mitigate the issue(s) itself and/or proactively present one or more notifications to an end user via the end user's device regarding the prediction. One such example notification is shown in FIG. 6.

Accordingly, in reference to FIG. 6, note that a GUI 600 may be presented on the display of the end user's device and include a notification or prompt 602 that a network bandwidth problem is expected to occur during a given session the user has started or will start shortly. Again, note that the session may be for a video conference but may also be for playing a video game online, remote access to another computer, streaming audio video content, etc. In certain examples, the session may even relate to single-device use in isolation, like graphics design, acoustic modeling, etc. on a laptop where issues might still arise among various components.

The GUI 600 may also include various selectors that the end user may then select to help address the bandwidth problem. For example, a selector 604 may be presented to command the user's own device or another system component (like a server hosting a video conference) to restart the session. Restarting the session may include closing and re-launching an application being used for the video conference or refreshing a local network connection, for example.

The GUI 600 may also include a selector 606 that may be selectable to command the end user's device to switch to a different LAN/Wi-Fi network than one to which the end user's device is currently connected in order to help address the bandwidth problem. The name of the different network being suggested by the device may also be presented on the selector 606 as shown.

Additionally, a selector 608 may be presented on the GUI 600 and may be selectable to command the end user's device to attempt to login to the video conference using a different conferencing service than the one the user is currently attempting to use for the video conference. For example, if the user were trying to use Zoom but sufficient bandwidth does not exist through Zoom's servers, the user may selector the selector 608 to use another service provider such as Teams that might have more bandwidth availability and/or less server load at the moment than Zoom's servers (as may also be indicated on the face of the selector 608 as shown). Thus, note that this example assumes that the different conferencing software apps can be used together for video conferencing through a unified communications platform being used by the system. Other reasons for selecting the selector 608 that are not shown but that might still be presented on the face of the selector 608 or elsewhere on the GUI 600 include the other provider's server having less memory load or less server errors or less load time, the other provider's client-side software and/or back-end server software having less bugs and failures, etc.

Still further, in some examples the GUI 600 may also include one or more recommendations 610 for other actions the end user might take to help address the bandwidth problem. In the present example, the recommendation 610 is to move with the device to a different location so that the device automatically connects to a different cellular base station (e.g., where a cellular data network is being used by the end user's device for the video conference call). Thus, it is to be understood that the recommendation 610 and remedies associated with the other selectors on the GUI 600 may dynamically change and be tailored to whatever is determined to be the cause of the bandwidth problem. So here, the recommendation 610 has been tailored responsive to a determination that the bandwidth problem lies with the local cellular base station to which the end user's device is connected.

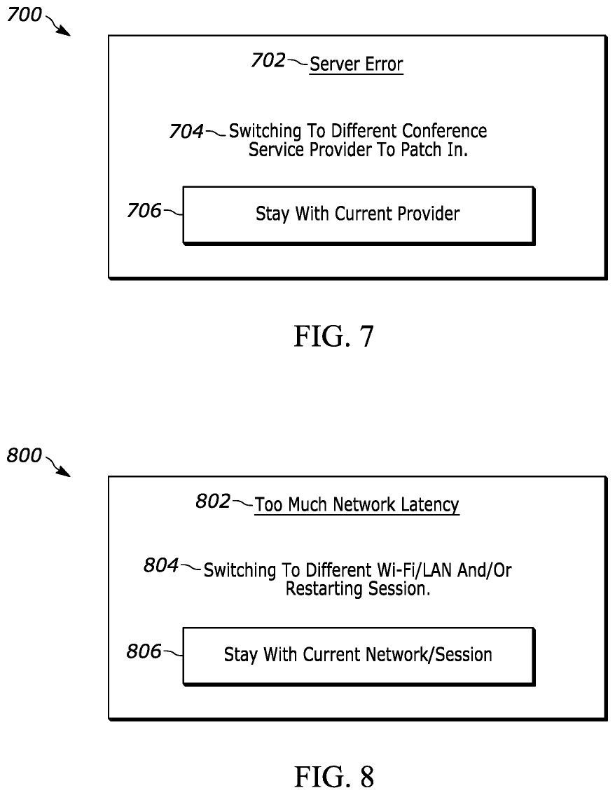

FIGS. 7-9 show additional example GUIs that may also be presented on the display of an end user's device, but where a system/server has already proactively taken action on its own to at least attempt to prevent or mitigate a system insufficiency itself. Beginning with FIG. 7, a GUI 700 may be presented that provides a prompt 702 that a server error has been detected or is expected to occur. The GUI 700 may also include an indication 704 of what action(s) the system is proactively taking to help fix or mitigate the server error, which in this case is switching to a different conferencing service provider than one the end user's device is currently attempting to use to conduct the video conference. However, if the user for any reason desires to continue using the current provider, selector 706 may be selected to provide a command to the device/system to continue using the current provider/app instead.

FIG. 8 shows another example where a GUI 800 may include a prompt 802 indicating that there exists an undue amount of network latency to effectively conduct the video conference call. Accordingly, an indication 804 is also presented that indicates that the system/end user's device is proactively restarting the video conference session and/or switching to a different Wi-Fi/LAN that might not be currently experiencing as much latency. But should the user still wish to have their device remain connected to the current network and/or maintain the current session, selector 806 may be selected to command the system/device to do so.

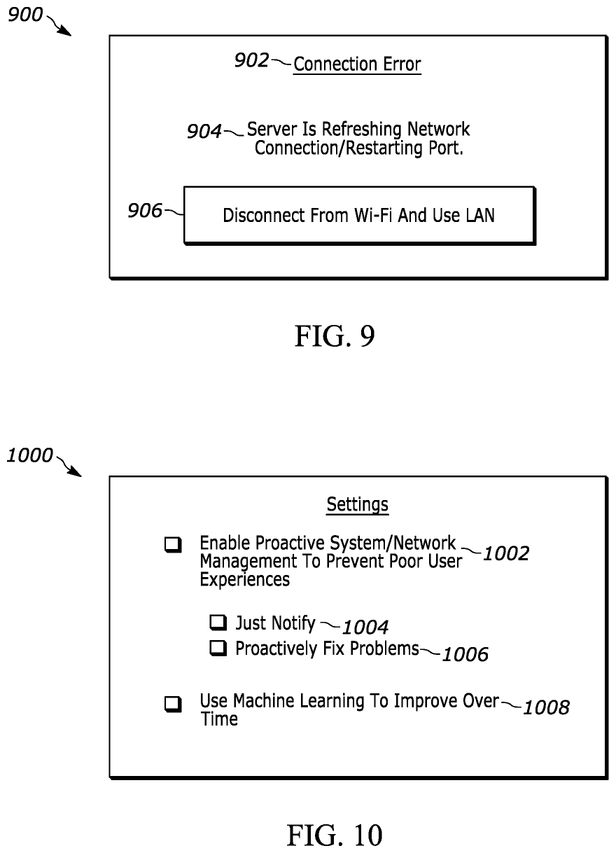

With reference to FIG. 9, it shows another example GUI 900 that may be presented on the end user's device. The GUI 900 may include a prompt 902 indicating that there has been a network connection error. Thus, an indication 904 may be presented that indicates that the server being used for the video conference is proactively refreshing its network connection to the end user's device (or that the end user's device is itself refreshing the connection on its end). The indication 904 might also indicate that a port on the server through which the end user's device is connecting is being restarted. However, to further assist, the end user might select the selector 906 to command their device to disconnect from a certain Wi-Fi network the end user's device is currently using for the video conference and to instead use a wired LAN connection to which the device also has access to attempt a better connection. Another selector (not shown) might also be presented that may be selectable to command the end user's device to refresh or restart an Internet browser being executed at the device if the browser is being used to facilitate the session to further help resolve the issue.

Continuing the detailed description in reference to FIG. 10, it shows an example settings GUI 1000 that may be presented on the display of an end user's device or server that operates consistent with present principles to configure one or more settings of the device/system to operate as described herein. In the present example, each option or sub-option discussed below may be selected by directing touch or cursor input to the respectively adjacent check box.

As shown in FIG. 10, the GUI 1000 may include a first option 1002 that is selectable to enable proactive system/network management to prevent poor user experiences. For example, the user may select the option 1002 to set or configure the device/system to in the future undertake the functions described above with respect to FIGS. 3 and 4, to execute the logic of FIG. 5, and/or to present the GUIs of FIGS. 6-9.

In some examples, the option 1002 may be accompanied by sub-options 1004 and 1006. Sub-option 1004 may be selected to set or configure the device/system notify the end user about system insufficiencies, while sub-option 1006 may be selected to set or configure the device/system to attempt to proactively remedy the insufficiencies itself. Both sub-options may be concurrently selected in certain examples so that both functions are executed for a given set of system data.

As also shown in FIG. 10, the GUI 1000 may include an option 1008 to set or enable the device/system to use machine learning to improve the AI model/ANNs that are being used over time to make better inferences in the future as described above.

It may now be appreciated that present principles provide for improved computer-based user interfaces that increase the functionality and ease of use of the devices disclosed herein. The disclosed concepts are rooted in computer technology for computers to carry out their functions.

It is to be understood that whilst present principals have been described with reference to some example embodiments, these are not intended to be limiting, and that various alternative arrangements may be used to implement the subject matter claimed herein. Components included in one embodiment can be used in other embodiments in any appropriate combination. For example, any of the various components described herein and/or depicted in the Figures may be combined, interchanged or excluded from other embodiments.

What is claimed is:

1. A first device, comprising:
at least one processor; and
storage accessible to the at least one processor and comprising instructions executable by the at least one processor to:
identify a first poor user experience with a system based on user input indicating the first poor user experience;
use data related to operation of the system to determine one or more causes of the first poor user experience;
predict that a second poor user experience will occur based on subsequent identification of one or more of the causes; and
based on the prediction, proactively prevent the second poor user experience from occurring and/or present a notification in advance of the second poor user experience.

2. The first device of claim 1, wherein the instructions are executable to:
based on the prediction, proactively prevent the second poor user experience from occurring.

3. The first device of claim 1, wherein the instructions are executable to:
based on the prediction, present a notification in advance of the second poor user experience.

4. The first device of claim 1, wherein the determination is performed using at least one artificial neural network (ANN) to process the data and infer from the data one or more system insufficiencies indicating the one or more causes.

5. The first device of claim 4, wherein the instructions are executable to:
train the ANN using the data as input.

6. The first device of claim 5, wherein the data is labeled with the one or more causes for training the ANN.

7. The first device of claim 6, wherein the data is labeled as being a poor user experience for training the ANN, the data labeled by the first device as being a poor user experience based on the user input.

8. The first device of claim 7, wherein the ANN is trained using one or more machine learning algorithms and the labeled data.

9. The first device of claim 8, wherein the ANN is trained using a multi-label classification learning algorithm.

10. The first device of claim 5, wherein the prediction is made using the trained ANN.

11. The first device of claim 4, wherein the prediction is made using the ANN.

12. The first device of claim 1, wherein the system comprises the first device, a second device different from the first device and associated with an end user, and/or a server providing an online service to an end user.

13. A method, comprising:
determining an insufficiency of a system based on input from an end user indicating the insufficiency exists in a first instance;
using first data related to the system to identify one or more reasons for the insufficiency;
determining that the insufficiency has or will occur again based on subsequent identification of one or more of the reasons from second data different from the first data, the second data also related to the system, the second data corresponding to a second instance occurring after the first instance; and
based on determining that the insufficiency has or will occur again, proactively addressing the insufficiency.

14. The method of claim 13, wherein the insufficiency is proactively addressed by attempting to prevent or mitigate the insufficiency.

15. The method of claim 13, wherein the insufficiency is proactively addressed by presenting a notification at an end-user device regarding the insufficiency.

16. The method of claim 13, comprising:
using at least one artificial neural network (ANN) to infer, from the second data, that the insufficiency has or will occur again.

17. The method of claim 16, wherein the ANN is trained using the first data and at least one machine learning algorithm.

18. At least one computer readable storage medium (CRSM) that is not a transitory signal, the computer readable storage medium comprising instructions executable by at least one processor to:
determine an insufficiency related to a system in a first instance;
analyze first data related to the first instance;
based on the analysis, determine that the insufficiency has or will occur again based on second data different from the first data, the second data also related to the system, the second data corresponding to a second instance occurring after the first instance; and
based on determination that the insufficiency has or will occur again, proactively address the insufficiency.

19. The CRSM of claim 18, wherein the instructions are executable to:
determine the insufficiency related to the system in the first instance based on user input indicating the insufficiency exists in the first instance.

20. The CRSM of claim 18, wherein the analysis is used to recognize a pattern in the second data that is similar to a pattern indicated in the first data, wherein recognition of the pattern from the second data contributes to the determination that the insufficiency has or will occur again, and wherein the system in the first and second instances is facilitating a video conference.
